(19) United States
(12) Patent Application Publication
(10) Pub. No.: US 2008/0201583 A1
(43) Pub. Date: Aug. 21, 2008

(54) POWER SUPPLY CONTROL CIRCUIT

(75) Inventors: Toru Fujiwara, Kato (JP); Akira Minami, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/968,268

(22) Filed: Jan. 2, 2008

(30) Foreign Application Priority Data
Feb. 16, 2007 (JP) 2007-036619

(51) Int. Cl. G06F 1/26

(52) U.S. Cl. 713/300

(57) ABSTRACT

A power supply control circuit has an input unit which receives a supply of a power supply from one or a plurality of power supply source apparatuses, and has plural input lines including a first input line and a second input line at least, an output unit which outputs the supplied power supply to a power supply destination apparatus, a current control unit which is arranged between the first input line and the output unit, and includes a first diode D1 and a field effect transistor FET which are connected in parallel, a connection detection unit which is arranged between the second input line and the current control unit, detects a state of supplying the power supply to the second input line, and controls the field effect transistor FET and a second diode D2 arranged between the second input line and the output unit.

### CROSS-REFERENCE TO RELATED APPLICATION

This application is related to Japanese Patent Application No. 2007-036619 filed on Feb. 16, 2007 whose priority is claimed under 35 USC §119 and the disclosure of which is incorporated by reference in its entirety.

### BACKGROUND OF THE INVENTION

1. Field of the Invention

The present invention relates to power supply control circuits and, more particularly, relates to a power supply control circuit which supplies electric power to electronic equipment connected to an information processing apparatus such as a personal computer.

2. Description of the Related Art

An externally mounted storage device (hard disc) and a recording and reproducing apparatus for a recording medium are hitherto used, being connected to a personal computer (referred to as PC); however, there exist various standards (SCSI, IEEE 1394, and the like) in their connection interfaces. Particularly, there is generally often used a universal serial bus (referred to as USB), IEEE 1394 in which a connection interface cable can be inserted and removed (referred to as hot-plug) while a PC remains in a powered on state.

Nowadays, a portable hard disc (referred to as HDD) using a USB interface is also on sale.

In addition, in electronic equipment using the USB interface, there is one which operates using only electric power supplied from the USB interface even when a 100 V external power supply is not used.

However, since there is required an increase in high speed rotation of a disc or the like with an increase in HDD performance; it becomes difficult to operate by only a maximum supply current value (500 mA) corresponding to bus power standard of one USB.

That is, there is a case that a current not less than this supply current needs to be supplied in order to perform a normal operation.

Consequently, there is proposed the following technique as a method of supplying sufficient electric power for performing the normal operation.

Japanese Unexamined Patent Publication No. 2005-141732 proposes electronic equipment which includes two connectors which connect two USB cables, a voltage detection circuit which detects that a USB cable is connected to one of the connectors, and a switch group which performs ON operation in accordance with voltage detection of a voltage detection circuit; and supplies electric power to a USB device by adding electric power given from both cables when two USB cables are connected.

In addition, Japanese Unexamined Patent Publication No. 2002-73219 proposes an interface apparatus which supplies electric power to an external device by adding electric power respectively supplied from via not less than two cables such as a USB cable and an IEEE 1394 cable.

However, in the electronic equipment disclosed in Japanese Unexamined Patent Publication No. 2005-141732, when a voltage (for example, 5.3 V) higher than a voltage supplied to a connector which communicates with a personal computer PC (for example, Vc1 shown in FIG. 1 thereof, 5 V) is applied to a connector which does not communicate with a personal computer PC (for example, Vc2 terminal shown in FIG. 1), a current flows inversely from Vc2 to Vc1 on the PC side via Tr5 and Tr4.

There is a case where a circuit of an interface section on the PC side is damaged by the inverse flow. In addition, a circuit in a case where a voltage of Vc2 is high is also disclosed in Japanese Unexamined Patent Publication No. 2005-141732; however, three field effect transistors, four transistors, two diodes, and also a AND gate are required; and consequently, a large number of elements is required and it becomes expensive.

Furthermore, in the interface apparatus disclosed in Japanese Unexamined Patent Publication No. 2002-73219, as shown in FIG. 4 thereof, a voltage to be supplied to an external device such as a compact disc read only memory (referred to as CD-ROM) drive can only supply a current by a voltage drop of a forward voltage of a diode (inverse current preventing circuit 15 shown in FIG. 4) connected to a USB cable or the like.

Under such circumstances, so-called a power supply loss is generated; and therefore, there is a possibility that an external device cannot be driven by only a power supply supplied by USB bus power connection. Particularly, an external device fundamentally operated by only electric power supplied from one USB cable has a voltage drop across a diode; and therefore, there is a case that plural USB cables have to be connected.

Consequently, it is desired to enable to suitably supply a power supply to electronic equipment having various operational power supply voltages.

For example, in a case of electronic equipment capable of sufficiently operating by supplying a power supply from one USB cable, it is desirable that only one USB cable is connected and plural USB cables are not required to be connected.

In addition, in a case of electronic equipment necessary for a power supply current supplied from a plurality of USB cables, no current is required to flow inversely to the PC side via the USB cable even when plural USB cables are connected. Further, even when an AC adapter which supplies an external power supply is used at the same time in addition to supplying a power supply from the USS cable, no current is desired to flow inversely to the PC side.

### SUMMARY OF THE INVENTION

The present invention provides a power supply control circuit comprising: an input unit which receives a supply of a power supply from one or a plurality of power supply source apparatuses, and has plural input lines including a first input line and a second input line at least; an output unit which outputs the supplied power supply to a power supply destination apparatus; a current control unit which is arranged between the first input line and the output unit, and includes a first diode D1 and a field effect transistor FET which are connected in parallel; a connection detection unit which is arranged between the second input line and the current control unit, detects a state of supplying the power supply to the second input line, and controls the field effect transistor FET; and a second diode D2 arranged between the second input line and the output unit.

In the power supply control circuit, directions in forward directions of the first diode D1, the second diode D2, and a parasitic diode existing between a drain and a source of the field effect transistor FET are the same as a power supply current flowing from the input unit to the output unit, and a forward voltage of the diode D1 is smaller than a forward voltage of the parasitic diode in the field effect transistor FET.

Accordingly, there is provided the power supply control circuit which can reduce a power supply loss in a case of supplying a power supply via one input line, and which can prevent a current from inversely flowing to the input line side in a case of supplying a power supply via plural input lines.

### BRIEF DESCRIPTION OF THE DRAWINGS

FIG. 1 is diagram for describing connection of one preferred embodiment of a power supply control circuit according to the present invention;

FIG. 2 is a schematic block diagram of one preferred embodiment of a power supply control circuit according to the present invention;

FIG. 3 is a diagram for describing supply of a power supply of one preferred embodiment of the power supply control circuit according to the present invention;

FIG. 4 is a diagram for describing supply of a power supply of one preferred embodiment of the power supply control circuit according to the present invention;

FIG. 5 is a diagram for describing one preferred embodiment of a USB power supply auxiliary cable according to the present invention;

FIG. 6 is a diagram for describing a preferred embodiment 1 of a power supply control circuit according to the present invention;

FIG. 7 is a block diagram of a preferred embodiment 2 of a power supply control circuit according to the present invention;

FIG. 8 is a diagram for describing the preferred embodiment 2 of a power supply control circuit according to the present invention;

FIG. 9 is a diagram for describing the preferred embodiment 2 of a power supply control circuit according to the present invention;

FIG. 10 is a diagram for describing a preferred embodiment 3 of a power supply control circuit according to the present invention;

FIGS. 11A and 11B are diagrams for describing one preferred embodiment of a cable provided with a power supply control circuit according to the present invention;

FIG. 12 is a diagram for describing one preferred embodiment of a cable provided with a power supply control circuit according to the present invention;

FIG. 13 is a diagram for describing one preferred embodiment of electronic equipment provided with a power supply control circuit according to the present invention; and

FIG. 14 is a diagram for describing one preferred embodiment of electronic equipment provided with a power supply control circuit according to the present invention.

### DESCRIPTION OF THE PREFERRED EMBODIMENTS

The present invention is a power supply control circuit capable of effectively supplying a current necessary for operating electronic equipment via one or a plurality of cables capable of supplying a power supply without generating problems such as the above mentioned power supply loss and inverse flow of current.

The present invention provides a power supply control circuit including: an input unit which receives a supply of a power supply from a power supply source apparatus, and has plural input lines; an output unit which outputs the supplied power supply to a power supply destination apparatus; a current control unit which is arranged between a first input line IN1 and the output unit, and includes a field effect transistor FET and a first diode D1 which are connected in parallel with each other to the first input line IN1; a connection detection unit which detects that a power supply is supplied to an input line different from the first input line IN1, and controls the field effect transistor FET; and a second diode D2 arranged between the input line different from the first input line IN1 and the output unit, wherein directions in forward directions of the first and the second diodes are the same as a flowing direction of a power supply current, and the connection detection unit controls the field effect transistor so that the power supply current supplied from the first input line IN1 flows to the output unit via the field effect transistor FET in a case where the connection detection unit detects that the power supply is not supplied to the input line different from the first input line IN1, and the power supply current supplied from the first input line IN1 flows to the output unit via the first diode D1 in a case where the connection detection unit detects that the power supply is supplied to the input line different from the first input line IN1.

Further, the input unit includes two input lines, and each of the input lines includes a signal line which transmits a signal and a power supply line which supplies a power supply.

However, in such a case, the signal line is not used in the power supply control circuit. According to this configuration, a publicly known interface cable can be used as it is, and only a power supply supply line thereof can be utilized. In a USB cable for example, only a Vbus line and a GND line are to be utilized.

Further, the input unit includes two input lines, the first input line includes a signal line which transmits a signal and a power supply line which supplies a power supply, and the second input line includes only a power supply line which supplies a power supply.

In such a case, the second input line may be capable of connecting an AC adapter.

Further, the input line may be capable of connecting a hot-pluggable interface cable, such as a USB cable and a IEEE cable.

The field effect transistor FET is arranged so that a direction in a forward direction of a parasitic diode existing between a drain and a source thereof is the same as the direction in the forward direction of the first diode D1.

The diode D1 effectively functions with respect to a parasitic diode in an FET connected in parallel. In this case, a diode having a forward voltage lower than a forward voltage of the parasitic diode needs to be used as D1. For example, a Schottky barrier diode having a very small forward voltage may be used as D1.

The drain of the field effect transistor FET and an anode of the first diode D1 may be connected to the first input line, and the source of the field effect transistor FET and a cathode of the first diode D1 may be connected to the output unit.

An anode of the second diode D2 may be connected to the second input line, and a cathode of the second diode D2 may be connected to the output unit.

The input unit may include two input lines, and the second diode D2 may not be provided in a case where a power supply voltage (V2) supplied from the second input line is equivalent to or higher than a power supply voltage (V1) supplied from the first input line.

The present invention provides an interface connection cable including: a power supply control circuit as described above; an input side cable which connects the input unit to the power supply source apparatus; and an output side cable which connects the output unit to the power supply destination apparatus.

Further, the present invention provides a power supply destination apparatus which receives a supply of a power supply from a power supply control circuit as described above, wherein the power supply control circuit is provided in the apparatus.

In the present invention, the “power supply source apparatus” means an information processing apparatus such as a personal computer (referred to as PC), and means an apparatus for supplying a power supply to electronic equipment connected to the information processing apparatus via a specific interface such as a USB and IEEE 1394.

In addition, the “power supply destination apparatus” means an externally mounted hard disc, a recording and reproducing apparatus for media such as a compact disc (referred to as CD), a digital versatile disc (referred to as DVD), and the like; and means electronic equipment which performs a specific operation by receiving a supply of a power supply from the information processing apparatus.

One or a plurality of interface connection cables is connectable to the input unit of the present invention. The number of the input line is the same as the number of connectable interface cables. In addition, a power supply current supplied via one interface connection cable is inputted via one input line.

In this case, each interface cable includes a signal line; however, a signal line to be actually used is only a first input line.

In a case where power supply currents are supplied via a plurality of interface connection cables, those power supply currents are combined (added) by the output unit and the resultant current is given to the power supply destination apparatus.

The output unit has one output line, and a power supply destination apparatus is connected to the output line.

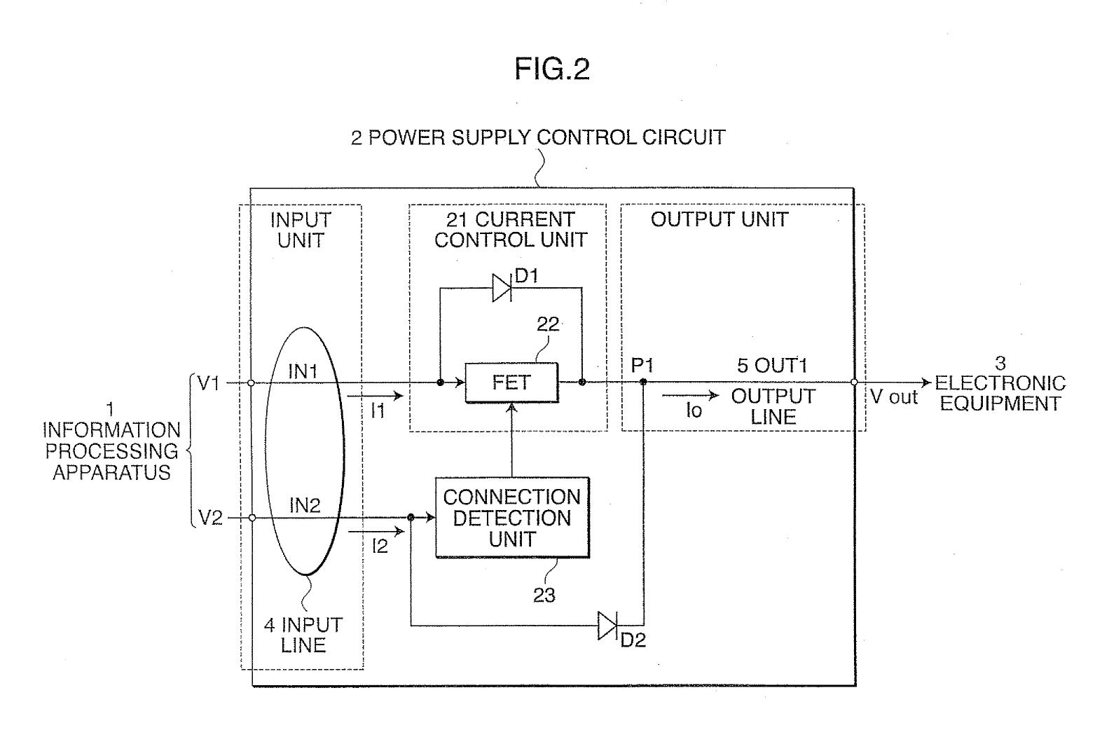

In addition, a power supply current outputted from the current control unit and a power supply current outputted from the second diode D2 are added by the output unit; and the resultant current is given to an external power supply destination apparatus via the output line. A point (node) where the above two power supply currents are added corresponds to a point P1 shown in FIG. 2 or the like to be described later.

The present invention will be described in detail below on the basis of preferred embodiments shown in the drawings. In addition, the present invention is not limited to this.

### <General Description of Power Supply Control Circuit>

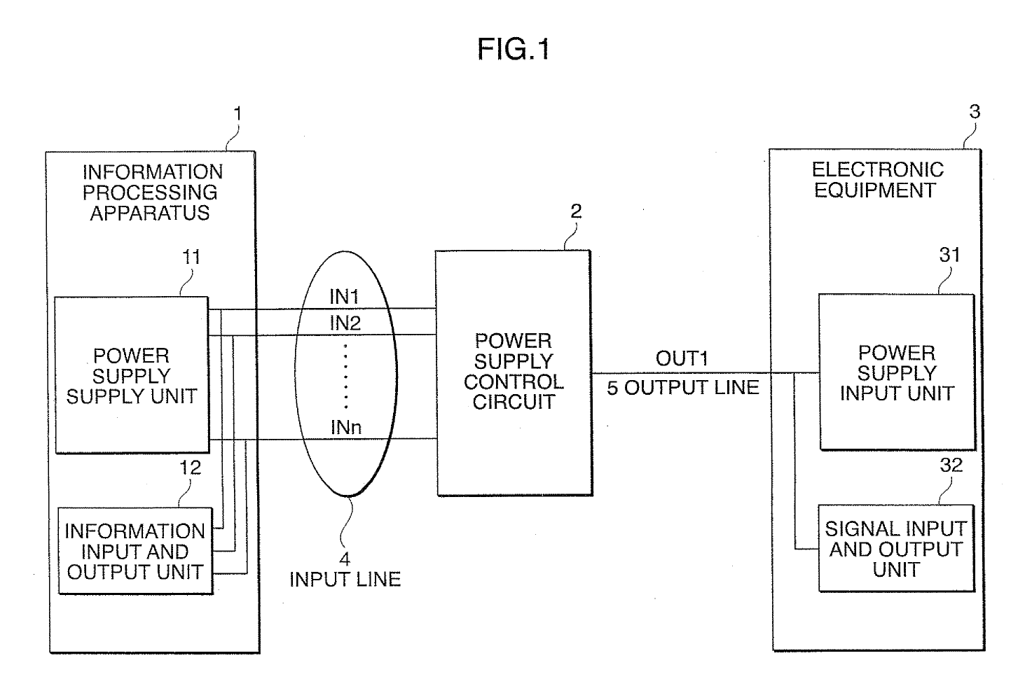

FIG. 1 is diagram for describing connection of one preferred embodiment of a power supply control circuit according to the present invention.

In FIG. 1, a power supply control circuit 2 is arranged between an information processing apparatus 1 (power supply source apparatus) such as a personal computer PC and external electronic equipment 3 (power supply destination apparatus) such as a DVD recorder and an HDD.

The power supply control circuit 2 and the information processing apparatus 1 are connected by one or a plurality of input lines 4 (IN1, IN2, . . . , and INn).

One input line 4 corresponds to a line capable of connecting a USB cable and an IEEE1394 cable, for example; and the input line 4 includes plural signal lines and a power supply line.

The signal line is a line which transmits a signal, and is connected to an information input and output unit 12 of the information processing apparatus 1.

The power supply line is a line which supplies a power supply, and includes a +5 V direct current voltage supply line and a GND line (0 V), for example; and the power supply line is connected to a power supply supply unit 11 of the information processing apparatus 1.

The power supply control circuit 2 and the electronic equipment 3 are connected by one output line 5 (OUT1). The output line 5 includes a signal line and a power supply line.

The signal line of the output line 5 gives a signal transmitted via the signal line of the input line 4 to a signal input and output unit 32 of the electronic equipment 3. In this regard, however, in the signal lines for use in the electronic equipment, only a first input line IN1 is used.

In addition, the power supply line gives a power supply voltage and current outputted from the power supply control circuit 2 to a power supply input unit 31 of the electronic equipment 3.

Furthermore, as to be described later, the power supply control circuit 2 detects a voltage applied to one or a plurality of power supply lines included in the input line 4; controls a current flown in via the an input line 4; and outputs the resultant current to the power supply line of the output line 5.

For example, in a case where the input line 4 includes two input lines (IN1 and IN2), currents (I1 and I2) flown in via two power supply lines are added by the power supply control circuit 2; and the resultant current is outputted to the power supply line of the output line 5.

In addition, in a case where the input line 4 is one input line IN1, a power supply current I1 supplied from the power supply line which is included in the input line IN1 thereof is directly outputted to the power supply line of the output line 5.

In a case where an interface cable (input line 4) connecting the information processing apparatus 1 and the power supply control circuit 2 is a USB cable, the input line 4 included in one USB cable includes four lines in total, which are two signal lines (D+ line and D− line), a direct current voltage supply line (Vbus line), and a GND line.

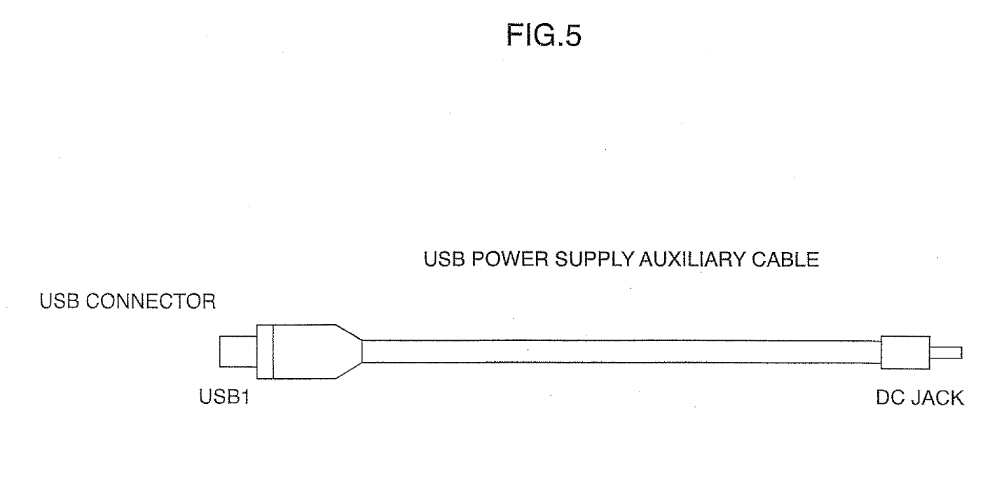

Furthermore, in the input line 4, in a case where IN1 is an input line including a signal line, input lines of IN2 to INn may be a power supply cable which supplies only a power supply in addition to an interface cable involving a signal line such as the USB cable. For example, a USB power supply auxiliary cable shown in FIG. 5 may be used. In the cable, only the lines of Vbus and GND in USB are connected to a DCJack male connector.

In addition, as one of the input lines 4, there may be used a line capable of connecting an AC adapter which converts an external power supply (commercial AC power supply 100 V or the like) into a direct current.

The thus connected power supply control circuit 2 outputs a power supply supplied via the input line 4 to the output line 5 with almost no loss in a case where only the input line IN1 is used; and in a case where a power supply is supplied via plural input lines, the supply control circuit 2 prevents a power supply current from inversely flowing to the input line 4 side when there is a difference in voltage to be applied to the power supply line of the input line 4.

FIG. 2 is a schematic configuration block diagram showing one preferred embodiment of a power supply control circuit 2 according to the present invention.

As shown in FIG. 2, the power supply control circuit 2 includes a current control unit 21 connected to one input line IN1, a connection detection unit 23 connected to an input line IN2 which is different from the above input line IN1, and a diode D2. A section including two input lines corresponds to an input unit; and a section including one output line corresponds to an output unit.

The current control unit 21 includes a field effect transistor FET 22 and a diode D1.

The current control unit 21 outputs a current given from the input line IN1 by turning ON or OFF the FET 22 via mainly the FET or via the diode D1.

ON or OFF control of the FET 22 is performed by a signal given from the connection detection unit 23 to a gate. G of the FET 22.

The diode D1 is connected such that a direction in which a power supply current is supplied serves as a forward direction. That is, an anode of the diode D1 is connected to the input line IN1; and a cathode of the diode D1 is connected to the output line of the output unit.

Furthermore, when a drain D of the FET is connected to the input line 4 side and a source S of the FET is connected to the output line 5 side, the diode D1 is connected in parallel to the FET 22 so that a direction from the drain D to the source S of the FET becomes a forward direction.

In addition, in a case where the FET is a P channel FET, a direction in a forward direction of a parasitic diode existing between the drain D and the source S conforms to a direction in the forward direction of the first diode D1.

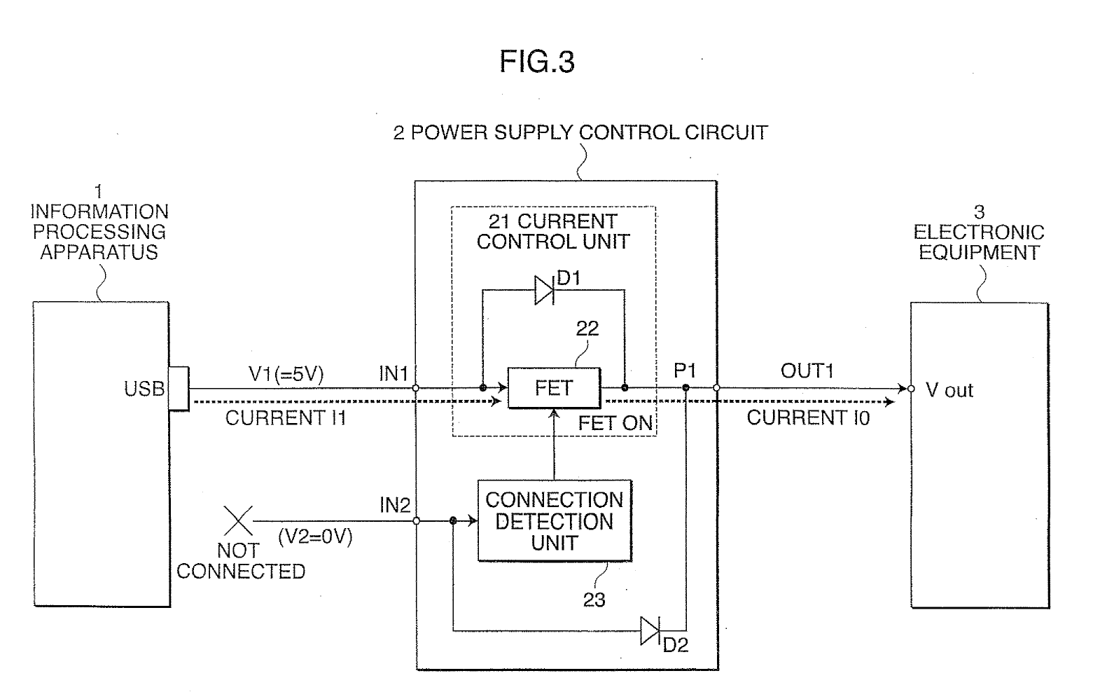

When FET 22 is in an ON state, a current flowing in from the input line IN1 is outputted to the output line 5 (OUT1) from the drain D via the source S of the FET 22 (refer to FIG. 3). At this time, a current scarcely flow via the diode D1.

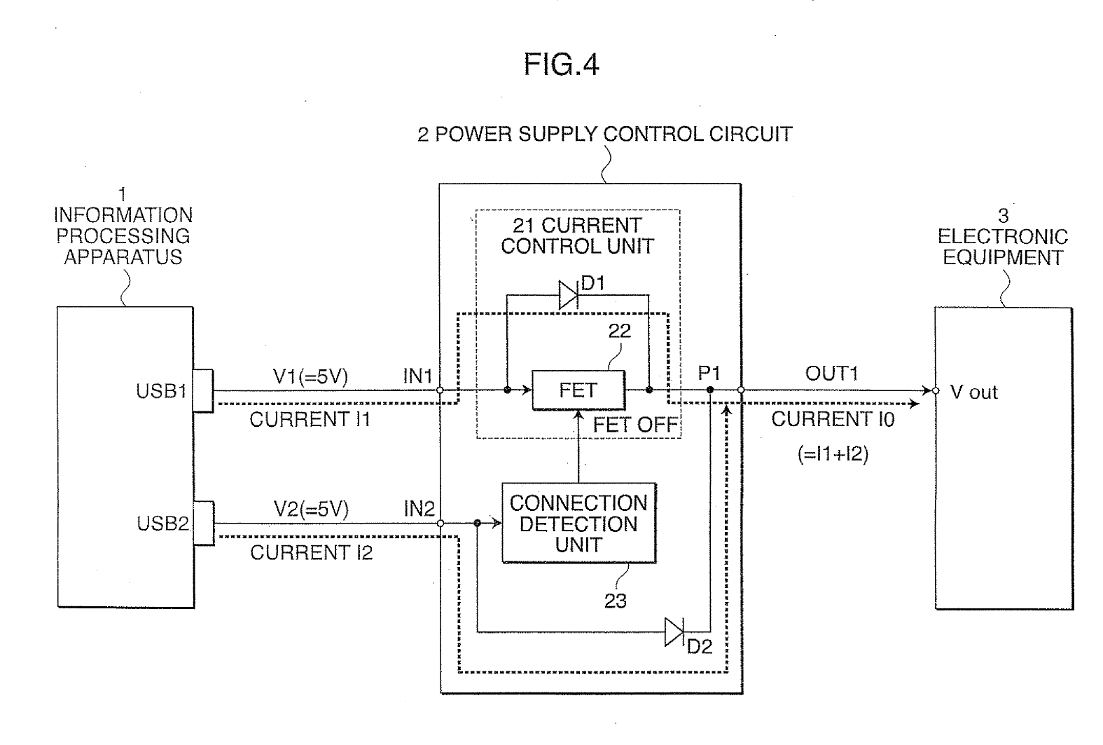

In addition, when the RET 22 is in an OFF state, a current flowing in from the input line IN1 does not flow from the drain D via the source S of the FET 22; but, the current is outputted to the output line 5 (OUT1) via the diode D1 (refer to FIG. 4).

The connection detection unit 23 is a section which changes a signal to be given to the FET 22 according to a voltage value of other input line IN2 different from the input line IN1.

For example, as shown in FIG. 3 to be described later, in a case where the input line IN2 is not connected (V2=0 V), the signal is not outputted to the gate G of the FET 22. At this time, the FET 22 is in an ON state, a current flows from the drain D to the source S of the FET.

Therefore, a P channel type FET (Pch FET) in which the drain D and the source S are conductive in an initial state where the signal is not given to the gate G is used for the FET 22.

In addition, in a case where the input line IN2 is connected to the information processing apparatus 1 and when a voltage (for example, V2=5 V) is applied as in the input line IN1, the connection detection unit 23 detects the potential V2 and gives a signal to the gate G of the FET 22. With this configuration, the FET 22 is in an OFF state, and a current does not flow from the rain D to the source S of the FET.

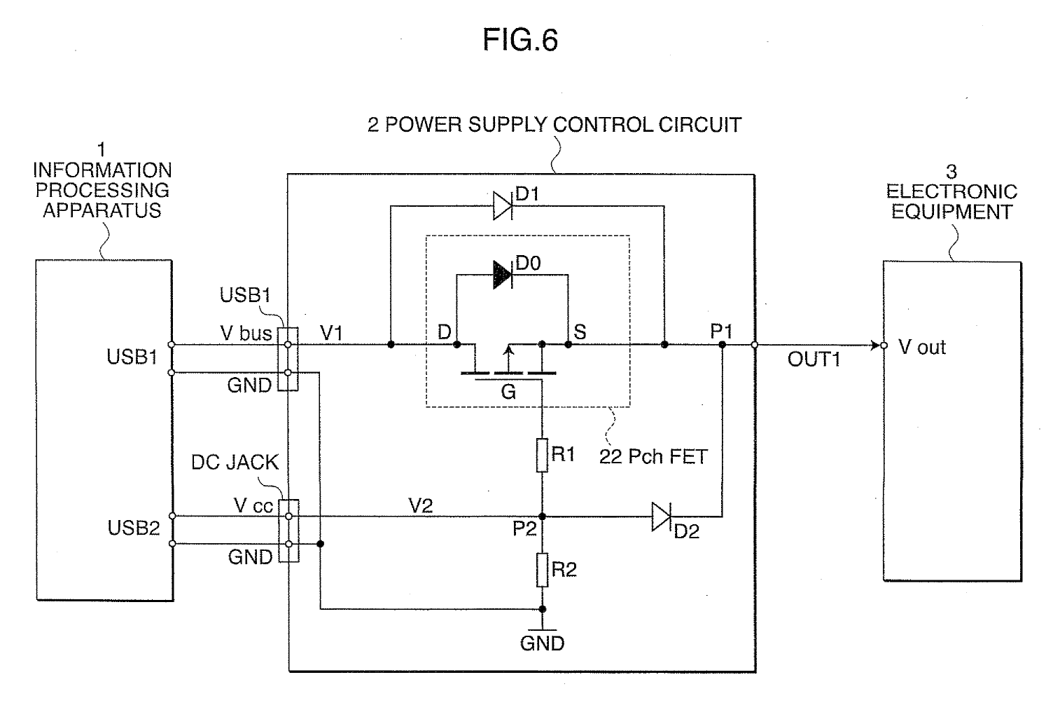

The connection detection unit 23 can be realized by various circuits. For example, the connection detection unit 23 can be realized by two resistors (R1 and R2) as shown in FIG. 6 to be described later.

In addition, the connection detection unit 23 may be configured by a switch in which a contact opens or closes when the cable of the input line IN2 is inserted into or pulled out from a connector of the information processing apparatus 1.

In this case, the power supply line of the input line IN2 is directly connected to the diode D2.

For example, it is configured such that the contact of the switch opens when the input line IN2 is not connected to the information processing apparatus 1. At this time, it is in an initial state which does not give the signal to the gate G of the FET and the FET is in an ON state.

Furthermore, it is configured such that the contact of the switch closes when the input line IN2 is connected to the information processing apparatus 1. At this time, the signal is given to the gate G of the PET, and the FET is in an OFF state so that a current does not flow via the FET.

The diode D2 is connected to the input line IN2 side where the current control unit 21 is not connected, and is arranged so that a direction which is the same as a current supply direction is a forward direction.

That is, the diode D2 is configured such that a direction in which a power supply current flows from the information processing apparatus 1 to the electronic equipment 3 is the forward direction as in the diode D1.

An input side (anode) of the diode D2 is connected to the input line IN2, and an output side (cathode) of the diode 2 is connected to a point P1 of the output unit shown in FIG. 2. In this case, the point P1 is a point which is connected to the output line (OUT1), the source S of the FET 22, and the output side (cathode) of the diode D1.

The diode D2 has a function which prevents a current from inversely flowing from the output line 5 toward the input line IN2.

In this regard, however, as to be described later, the diode D2 may not be provided in a case where it is ensured that the power supply voltage V2 supplied from other input line IN2 is always higher than the power supply voltage V1 supplied from the input line IN1 connected to the current control unit 21, or both voltages are the same.

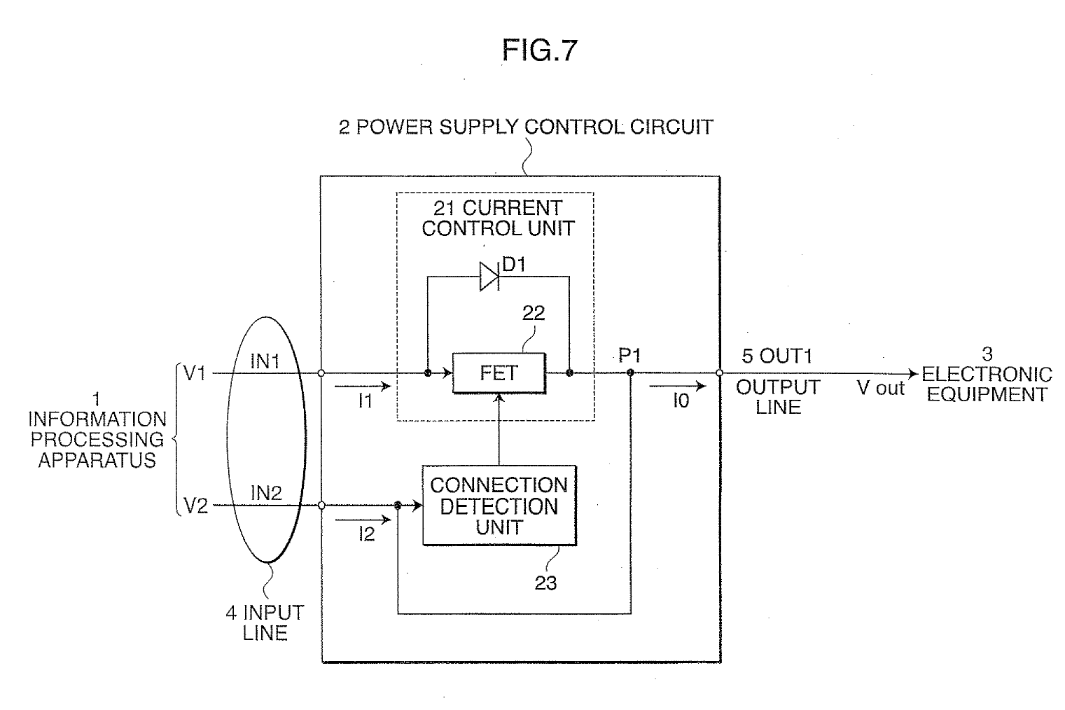

In this case, a circuit configuration having no diode D2 can be adopted as to be shown in FIG. 7.

A case where the power supply voltage V2 of the input line IN2 shown in FIG. 2 is higher than the power supply voltage V1 of the input line IN1 is a case, for example, where a USB interface cable is connected to the input line IN1, and an AC adapter is connected to the input line IN2.

This is because, generally, there are many cases that the power supply voltage supplied from the AC adapter is higher than the power supply voltage supplied via the USB cable.

In FIG. 2, in a case where the power supply current is supplied via two input lines (IN1 and IN2), the current I1 flowing via the input line IN1 and the current I2 flowing via the input line IN2 are combined at the point P1; and consequently, a larger current (I₀=I1+I2) is S outputted to the electronic equipment 3 (FIG. 4).

For example, even when an electronic equipment 3 cannot perform normal operation by only the power supply current I1 supplied via one USB cable, the electronic equipment can perform normal operation by the combined current I₀ (I1+I2) given via two input lines (IN1 and IN2).

In addition, the FET 22 has a characteristic which is low in on-resistance; and therefore, a voltage drop is scarcely generated even the current flows from the drain D to the source S.

Therefore, in a case where a power supply is supplied using only one input line IN1, if a current is flown via the FET 22; a power supply loss due to a voltage drop is scarcely generated, a power supply current as specified can be flown to the electronic equipment 3, and normal operation can be performed.

In FIG. 2, there is shown the preferred embodiment of the power supply control circuit in which two input lines (IN1 and IN2) are connected; however, it is possible to similarly supply a power supply even in a case where the number of the input line is N (N≧3).

### <Description of Operation for Supplying Power Supply>

Next, an operation for supplying a power supply of a power supply control circuit according to the present invention will be described.

FIG. 3 is a diagram for describing an operation in a case where a power supply is supplied from one USB cable (input line IN1).

FIG. 4 is a diagram for describing an operation in a case where a power supply is supplied from two input lines (IN1 and IN2).

In FIG. 3, an information processing apparatus 1 and a power supply control circuit 2 are connected via an input line IN1; and electronic equipment 3 and the power supply control circuit 2 are connected via an output line OUT1.

A terminal which connects an input line IN2 is provided in the power supply control circuit 2; however, the input line IN2 is not connected.

In a case where the input line IN1 is the USB cable, a power supply voltage (V1) of the input line IN1 is +5 V. On the other hand, a power supply voltage (V2) on the input line IN2 side is 0 V.

An FET 22 is in an ON state when a current can flow from a drain D to a source S in an initial state when there is not a signal input to a gate G, as described above.

At this time, a connection detection unit 23 detects that a cable is not connected to the input line IN2 because the power supply voltage V2 is 0 V, and a signal is not given to the gate G of the FET 22.

Therefore, since the signal is not inputted to the gate G of the FET 22, the FET 22 is in an ON state; and a current I1 flowing in via the input line IN1 is directly outputted to an output line OUT1 as a current I₀ (=I1) via from a drain D to a source S of the FET.

That is, an internal resistance of the FET 22 is very low and a voltage drop thereacross is lower than a voltage drop due to a forward voltage across the diode D1; and therefore, the current I1 flows mainly via only the FET 22, and does not flow via the diode D1.

By the way, in a case where there is not the FET, and the power supply current I1 is outputted to the output line OUT1 via only the diode D1; there is a case where sufficient power supply current I₀ is not supplied to the electronic equipment 3 due to a voltage drop across the diode D1. In this case, there is a case that the electronic equipment 3, in which an operation is guaranteed by a power supply current which is supposed to be supplied from one USB cable, cannot be normally operated because of shortage in supply current.

However, in the present invention, in a case of FIG. 3, a voltage drop due to the FET is scarcely generated; and therefore, the output current I₀ is almost the same value as the input current I1, and it is possible to normally operate the electronic equipment 3 in which the operation is guaranteed by a power supply supplied from one USB cable in conformity with the USB standard.

Next, FIG. 4 shows a case where an information processing apparatus 1 and a power supply control circuit 2 are connected using two USB cables (IN1 and IN2). At this time, the same power supply voltages (V1=V2=5 V) are supplied from two USB terminals (USB1 and USB2). Also in this case, only an input line IN1 is used for a signal line.

In addition, a USB cable (or, previously described USB power supply auxiliary cable) corresponding to an input cable IN2 is connected; and therefore, a connection detection unit 23 detects the power supply V2 (=5 V) and outputs the same to a gate G of an FET 22. With this configuration, the FET 22 is in an OFF state, and a current does not flow from a drain D to a source S of the FET.

Therefore, since the FET 22 is in an OFF state, a current I1 flowing in via the input line IN1 is outputted to an output line OUT1 via a diode D1 connected in parallel to the FET.

On the other hand, a current I2 flowing in via the input line IN2 is outputted to the output line OUT1 passing through a point P1 via the input line IN2 and a diode D2. Two currents I1 and I2 are added at the point P1.

In this case, since the currents flow via two diodes (D1 and D2); voltage drops are generated; however, a current I₀ flowing out from the output line OUT1 is almost the same as I1+I2.

As described, in a case of FIG. 4, the sum of the power supply currents supplied through two USB cables via two diodes (D1 and D2) is given to electronic equipment 3; and therefore, it is possible to operate electronic equipment 3 which is not normally operated by a power supply supplied from one USB cable.

In addition, two diodes D1 and D2 are used as inverse flow prevention elements; and therefore, it is possible to prevent a current from inversely flowing to the input line (IN1 and IN2) sides even when there generates a potential difference between the power supply voltages (V1 and V2) of two USB ports of the information processing apparatus 1.

In FIG. 4, there is shown an operation in a case where two USB cables are connected; however, also in a case where not less than three USB cables are connected as the input cable, electronic equipment which needs larger current can be similarly operated while preventing a current from inversely flowing.

In addition, as a preferred embodiment in which only a power supply line is connected as the input line IN2 as shown in FIG. 4, so-called an AC adapter may be directly connected to a connecting terminal of the input line IN2.

In this case, a harmful effect in a case where the diode D1 is not provided will be specified.

The diode D1 is connected in parallel to the FET, and direction thereof corresponds to a direction in a forward direction of a parasitic diode in the FET. In addition, a forward voltage (referred to as Vf) of the FET is generally larger than that of a Schottky barrier diode; and in this case, Vf of the FET is assumed to 0.8 V and Vf of the D1 is assumed to 0.4 V. In a case where the D1 is provided, a voltage at the P1 is 5 V-0.4 V=4.6 V; whereas in a case where the D1 is not provided, a voltage at the P1 is 5 V-0.8 V=4.2 V; and consequently, there is one which does not operate according to electronic equipment.

As mentioned above, the power supply control circuit 2 according to the present invention can surely operate operationally guaranteed electronic equipment in a case where the power supply is supplied from one input line; and in a case where the power supply is supplied from plural input lines, there have both characteristics in that electronic equipment which needs larger current can be operated and it is possible to prevent a current from inversely flowing even when there is a variation in power supply voltages in plural input lines.

### Preferred Embodiment of Power Supply Control Circuit

In this case, a specific circuit of a power supply control circuit 2 according to the present invention will be described.

### Preferred Embodiment 1

FIG. 6 is a diagram for describing a preferred embodiment 1 of a power supply control circuit according to the present invention. In this case, there is shown a case where two input lines are connected as in FIG. 2 or the like.

In FIG. 6, one of two input lines is a USB cable to be connected to a USB terminal (USB1) of an information processing apparatus 1. The other input line is a power supply line to be connected to a USB2 terminal of the information processing apparatus 1.

The USB cable includes two signal lines (D+ and D−) (not shown in the drawing), and two power supply supply lines (Vbus and GND). The input line to be connected to a DCjack includes a Vcc line and a GND line. In FIG. 6, the USB cable or a USB power supply auxiliary cable is used.

An FET 22 and a diode D1 shown in FIG. 2 or the like are connected in parallel in the Vbus line of the USB cable.

In this case, a P channel FET (Pch FET) is used for the FET 22.

An element which is as low voltage drop (forward voltage) as possible is desirable for the diode D1. For example, a Schottky barrier diode can be used.

In addition, there exists a parasitic diode D0, in which a direction from a drain D to a source S is a forward direction, in the Pch FET. Therefore, the drain D of the FET is connected to a Vbus terminal of an input line USB1.

This is because that a direction of the parasitic diode D0 existing in the FET becomes inverse with respect to a current flowing direction when the source S side of the FET is connected to the Vbus terminal; and in a case where an input voltage Vcc of other input line (DCjack) is higher than an input voltage of Vbus, the current inversely flows to the USB cable side via the parasitic diode D0.

In addition, the source S of the FET is connected to an output line OUT1. The diode D1 is arranged in parallel to the FET so that the forward direction is a direction of supplying a power supply.

Consequently, the diode D1 and the parasitic diode D0 of the FET 22 are arranged in the same direction. A forward voltage of the parasitic diode in the FET is generally higher than the forward voltage of the Schottky barrier diode. As an example, the forward voltage of the parasitic diode D0 is approximately 0.8 V whereas the forward voltage of the diode D1 is approximately 0.4 V.

In FIG. 6, the Vcc line and the GND line connected to the DCjack correspond to the input line IN2 shown in FIG. 2 or the like; and resistors R1 and R2 correspond to the connection detection unit 23 shown in FIG. 2.

A power supply supplied via the input line IN2 passes a point P2 between two resistors (R1 and R2), and is constantly given to a point P1 via a diode D2.

In a state where the cable is not connected to the DCjack, a voltage at the Vcc terminal is 0 V; and it becomes a state where a signal is not given to a gate G of the FET (so-called ON state) via a point P2 and the resistor R1.

On the other hand, when the cable is connected to the DCjack and a power supply voltage Vcc (=5 V) is supplied from the information processing apparatus 1, the voltage at the Vcc terminal becomes 5 V, and it becomes a state where a signal is given to the gate G of the FET (so-called OFF state).

In the Pch FET, a current Id flowing between the drain D and the source S is controlled by a voltage V_{GS} between the source S and the gate G. Generally, in a case where the voltage V_{GS} between the SG is near 0 V, for example, approximately V_{GS}=0 to 1.0 V; the current Id scarcely flows

In addition, when the voltage V_{GS} between the SG is not lower than 1.5 V, the current Id flows between the drain D and the source S.

In a state where the cable is not connected to the Vcc line corresponding to the input line IN2 when the USB cable is connected to the USB1 terminal and 5 V is supplied to the Vbus, a potential of the source S is 5 V; whereas since a potential of the gate G is 0 V, a voltage between the SG becomes V_{GS}=5−0=5 V; and consequently, the current Id flows from the drain D to the source S, and the FET becomes in an ON state.

Furthermore, in a state where the cable is connected to the Vcc line when the USB cable is connected to the USB1 terminal and 5 V is supplied to the Vbus, a potential of the source S of the FET is approximately 5 V; whereas since a potential of the gate G is also 5 V, a voltage between the SG V_{GS} becomes V_{GS}≈5−5=0 V; and consequently, it becomes an OFF state where the current Id scarcely flows between the drain D and the source S of the FET.

In the OFF state, a current does not flow via the FET; and therefore, a current I1 flowing in from the Vbus flows via the diode D1 (refer to FIG. 4).

In addition, in a case where the USB cable is not connected to the USB1, a potential at the Vbus terminal of the USB becomes 0 V; however, if the cable is connected to the DCjack and 5 V is supplied to the Vcc terminal, a power supply current is outputted to the output line OUT1 via the diode D2.

### Preferred Embodiment 2

In this case, there is described a preferred embodiment in a case where a diode D2 is not provided in a power supply control circuit 2.

As described before, the power supply control circuit 2 is a circuit adopted in a case where a voltage V2 which is supplied to an input line IN2 connected to a connection detection unit 23 is the same or higher (V2≧V1) than a voltage V1 which is supplied to an input line IN1 connected to a current control unit 21.

FIG. 7 is a block diagram showing a preferred embodiment 2 of a power supply control circuit according to the present invention.

In this case, it is different from FIG. 2 in that the diode D2 is not provided. In this regard, however, it is set to the voltage V2 of the input line IN2≧the voltage V1 of the input line IN1.

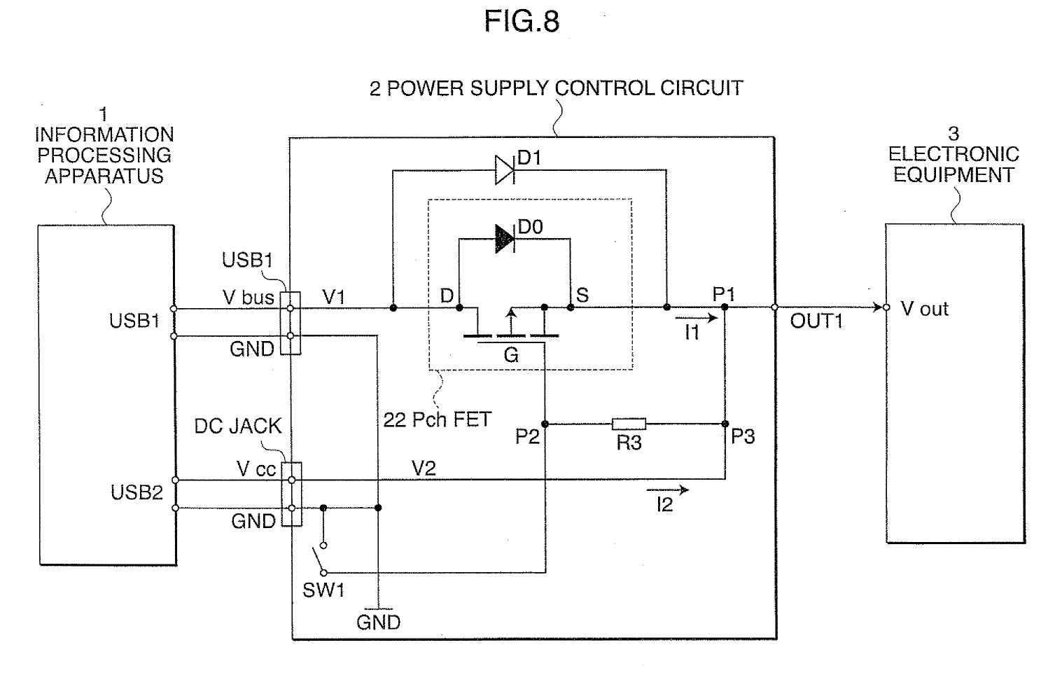

FIG. 8 is a diagram for describing a specific example of the preferred embodiment 2 of the power supply control circuit according to the present invention.

In this case, an FET 22 and a diode D1 on the Vbus terminal side in which a USB cable is connected are the same as those shown in FIG. 6.

A circuit between power supply lines (Vcc and GND) connected to a DCjack and a circuit point P1 is different from FIG. 6.

In FIG. 8, a section including a resistor (R3) and a switch SW1 corresponds to the connection detection unit 23. A switch, which closes when a cable is connected to a Vcc terminal such as a DCJack with a switch, is used for the switch SW1.

In addition, when the cable is pulled out from the Vcc terminal, a contact of the switch SW1 is opened to be in an OFF state.

In FIG. 8, in a case where the USB cable is connected to a USB1 terminal and the cable is not connected to the DCjack, a power supply current I1 flows via the FET 22 and is outputted from an output line OUT1, as in FIG. 3.

On the other hand, when a cable is connected between a USB2 and the Vcc terminal, a voltage (V2=5 V) is supplied to the Vcc terminal; and further, the contact of the switch SW1 closes and the SW1 becomes in an ON state.

In this case, a current I2 which is supplied by the voltage (V2) applied to the Vcc is given to a point P1 via a point P3.

In addition, when the switch SW1 is turned on, a potential of a gate G becomes 0 V; and consequently, a current does not flow between a drain D and a source S of the FET 22, and the FET 22 becomes in an OFF state.

Therefore, the current I1 supplied from the Vbus of the USB cable does not flow via the FET 22; but, the current I1 flows via the diode D1.

In FIG. 8, in a case where the cable is connected to the USB1 terminal and the DCjack, the current I1 flowing in via the diode D1 and the current I2 flowing in via the Vcc terminal are added at the point P1, and the resultant current is outputted to the output line OUT1.

In this case, as a precondition, the voltage V2 supplied to the Vcc of the DCjack is higher than the voltage V1 supplied to the Vbus (V2≧V1); and therefore, a current does not flow inversely from the point P1 to the Vcc terminal. Furthermore, in a case where the currents are supplied from two routes to the point P1, since the diode D1 is present, it is possible to prevent a current from inversely flowing to the Vbus terminal side even a potential on the electronic equipment 3 side fluctuates.

Also in a case of this preferred embodiment, a voltage drop due to the FET is scarcely generated; and therefore, electronic equipment in which normal operation is guaranteed by only electric power supply by one USB cable can be operated by one USB cable as specified; and, in a case of supplying a power supply via two input lines, it is possible to prevent a current from inversely flowing to the IN1 input line.

In addition, in a case where it is previously known that the voltage of the power supply for the input line connected to the connection detection unit 23 is higher than the power supply voltage for the input line connected to the current control unit 21, the power supply control circuit which omits the diode D2 can be adopted as shown in FIG. 8.

Also in the preferred embodiment 2, there is shown one which includes two input lines; however, it is possible to supply a power supply similarly even when not less than three input lines are used.

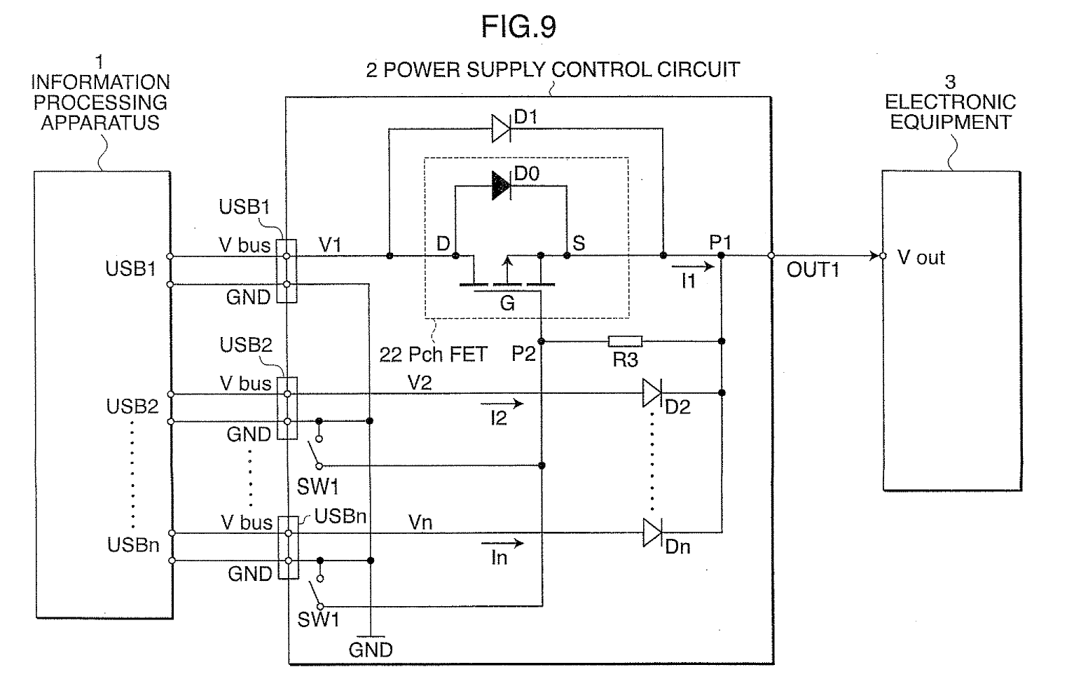

FIG. 9 is a diagram for describing the preferred embodiment 2 in a case where the number of input lines is n (n≧3).

This is one in which USBn terminals, switches, and diodes Dn are added as compared with FIG. 8.

In a case where n USB cables are connected, respective supply currents (I1, I2, . . ., and In) are added at a point P1 and the resultant current is outputted.

### Preferred Embodiment 3

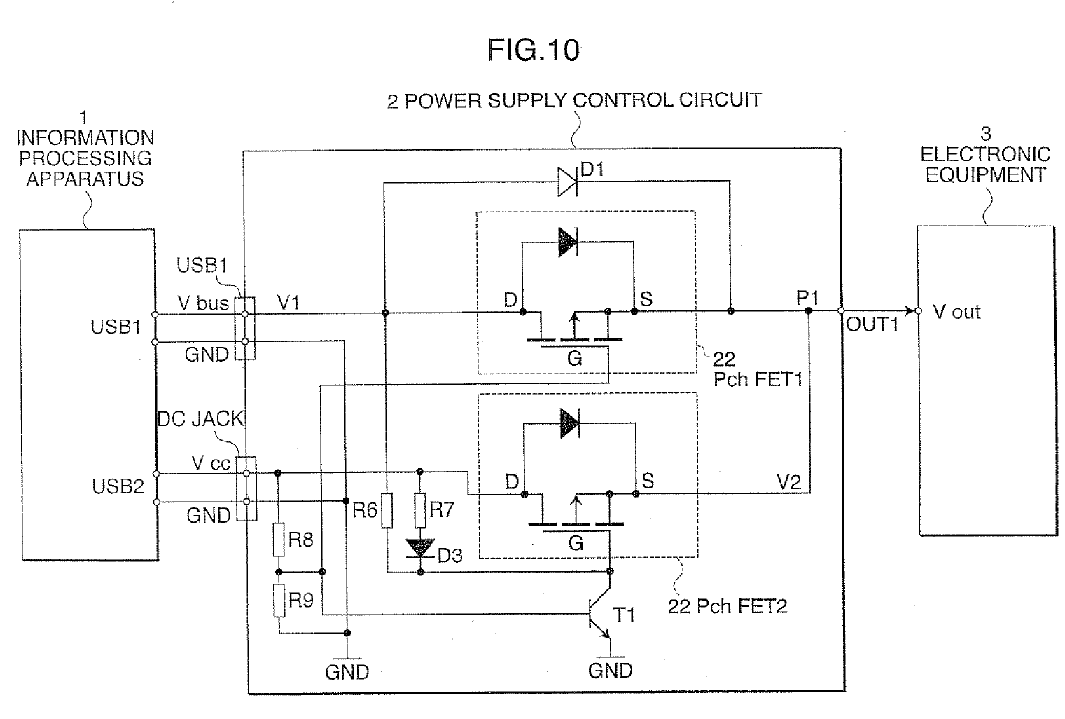

FIG. 10 is a diagram for describing a preferred embodiment 3 of a power supply control circuit according to the present invention.

The preferred embodiment 3 is also conditional on that a voltage V2 supplied to a Vcc of a DCjack is higher than a voltage V1 supplied to a Vbus of a USB (V2≧V1), and a diode D2 is not provided as in the preferred embodiment 2.

In FIG. 10, a Pch FET2, four resistors (R6 to R9), a transistor T1, and a diode D3 are provided at a section corresponding to the connection detection unit 23 shown in FIG. 7.

A Pch FET1 and a diode D1 connected to the Vbus are the same as those shown in FIG. 2, FIG. 6, and FIG. 7; and an operation for supplying a power supply are also the same.

In FIG. 10, two FETs 22 are a P channel type FET having the same characteristic, a drain D is arranged on the input line side, and a source S is arranged on the output line side.

First, an operation in a case where a USB cable is connected to only a USB1 and a power supply cable is not connected to a DCjack will be described.

In this case, since only USB cable is connected, a voltage (=5 V) is supplied to the Vbus terminal; and a G of the FET1 becomes 0 V; and therefore, the FET1 becomes in an ON state. Therefore, a current flows to a point P1 via the FET1.

In the FET2, since the cable is not connected to the DCjack, a voltage of the Vcc becomes 0 V and a current cannot flow to the T1; 5 V is supplied to a G of the FET2 from V1 via the R6; and therefore, the FET2 becomes in an OFF state.

In this case, the diode D3 shown in FIG. 10 is provided to prevent a current from inversely flowing to the Vcc terminal side.

Also in this case, similarly to those shown in FIG. 3, a bog-standard power supply current is given to electronic equipment 3 via one USB cable. In addition, voltage appearance to the DCJack side which is not connected can be also blocked.

Next, there will be described a case where the USB cable is not connected to the USB1 terminal, but only the power supply cable is connected to the DCjack terminal.

In this state, since the USB cable is not connected, transmitting and receiving of data is not performed. This corresponds to a case where only a power supply is supplied to the electronic equipment 3 via the power supply cable. In this case, the FET1 connected to the Vbus becomes in an OFF state.

On the other hand, a potential 5 V is given to the S of the FET2 via a parasitic diode in the FET2 connected to the Vcc. In addition, the G of the FET2 is 0 V; and accordingly, the FET2 connected to the Vcc becomes in an ON state. Therefore, a current flowing in from the Vcc terminal is flown out to the point P1 via the FET2. In this case, one of the current from the Vcc is supplied to a collector of the T1 passing through R7 and D3, and the other is divided by the R8 and the R9 to be supplied to a base of the T1; and therefore, the transistor T1 is turned ON. Then the gate G of the FET2 become a potential (L state) of 0 V; and therefore, the FET2 becomes in an ON state.

In addition, the FET1 connected to the Vbus is in an OFF state, and the diode D1 is present; and therefore, it is possible to prevent a current from inversely flowing to the Vbus terminal from the point P1.

Next, there will be described a case where the USB cable is connected to the USB1 terminal and the power supply cable is connected to the DCjack terminal. In this case, since the FET1 becomes in an OFF state, a current flows from the Vbus terminal via the diode D1, as in FIG. 3.

On the other hand, the S of the FET2 is 5 V, one of the current from the Vcc is supplied to the collector of the T1 passing through the R7 and the D3, and the other is divided by the R8 and the R9 to be supplied to the base of the T1; and therefore, the transistor T1 is turned ON. Then the gate G of the FET2 becomes a potential (L state) of 0 V; and therefore, the FET2 becomes in an ON state. Therefore, the current flowing in from the Vcc terminal flows to the point P1 via the FET2. Therefore, the current via the diode D1 and the current via the FET2 are added at the point P1, and the resultant current is outputted to the output line.

### Description of Preferred Embodiment of Power Supply Control Circuit

As shown FIG. 1, the power supply control circuit 2 according to the present invention is arranged at an interface section between the information processing apparatus 1 and the electronic equipment 3.

It is possible to provide as a small power supply controller which includes only the power supply control circuit 2, and is provided with an input terminal group which is for connecting a cable (for example, USB cable) connected to the information processing apparatus 1 and an output terminal which is for connecting a cable (for example, USB cable) connected to the electronic equipment 3. In this case, however, a large number of cables and the power supply controller need to be connected; and therefore, it takes a lot of trouble in connection.

Consequently, from the viewpoints of reduction in product cost and easiness in user's connection, the following preferred embodiment of the power supply control circuit can be conceivable.

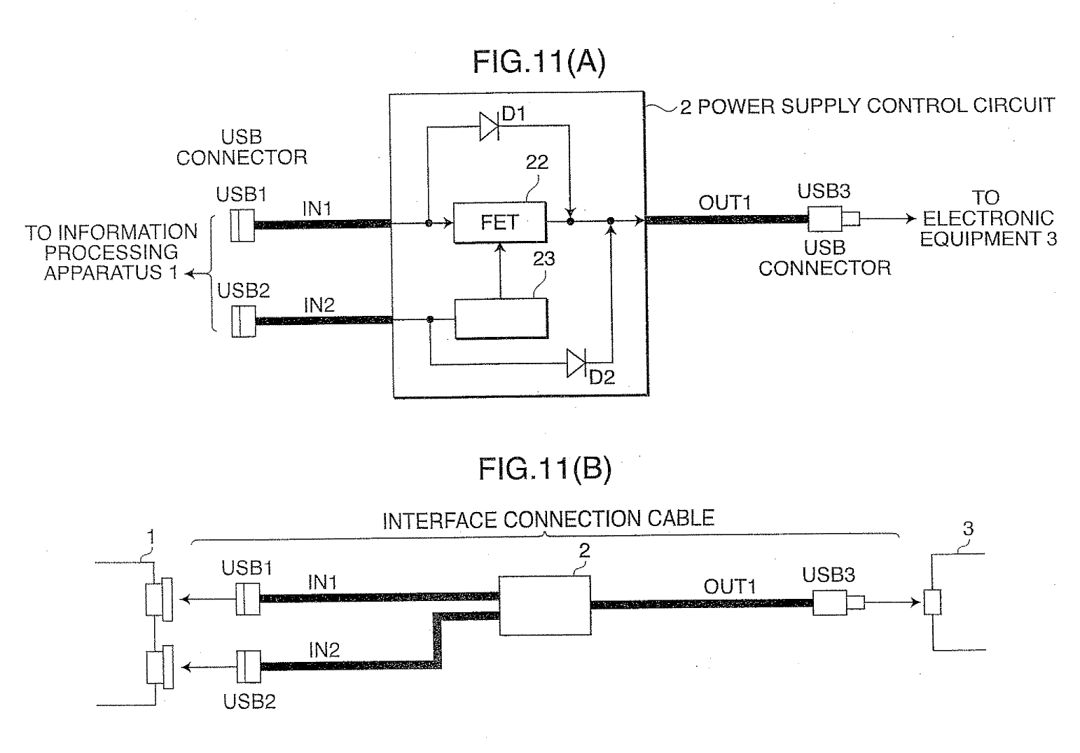

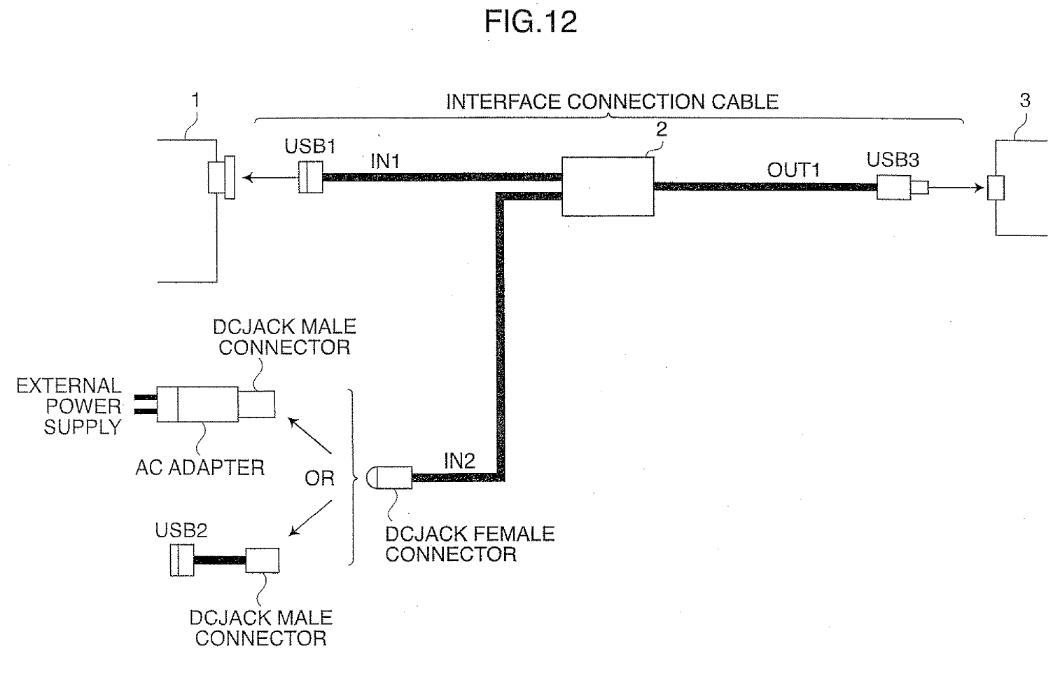

FIGS. 11 and 12 are diagrams for describing preferred embodiments which incorporate a power supply control circuit according to the present invention in an interface connection cable.

For example, as shown in FIGS. 11A and 11B, a power supply control circuit 2 is provided at the central portion of the interface connection cable; and two input side cables (IN1 and IN2) for connecting an information processing apparatus 1 and an output side cable (OUT1) for connecting electronic equipment 3 are directly attached to the power supply control circuit 2.

In addition, USB connectors (USB1 and USB2) connectable to sockets of the information processing apparatus 1 are mounted at the ends of two input side cables (IN1 and IN2). A connector (USB3) having a shape connectable to a socket of the electronic equipment 3 is mounted at the end of the output side cable (OUT1).

In this regard, however, the power supply control circuit 2 does not need to be arranged at just the center of the cable; but, lengths of the input side cable and the output side cable may be different.

An interface connection cable shown in FIG. 12 is the same as those shown in FIG. 11 in that a power supply control circuit 2 is provided at the interface connection cable; however, a DCJack female connector is provided in place of the USB2 connector.

FIG. 12 shows a case where the DCJack female connector is connected to an external power supply via an AC adapter, and a case where a USB power supply auxiliary cable is connected.

Data is transmitted from a USB1 via a USB cable, and a power supply is supplied via two input lines (IN1 and IN2).

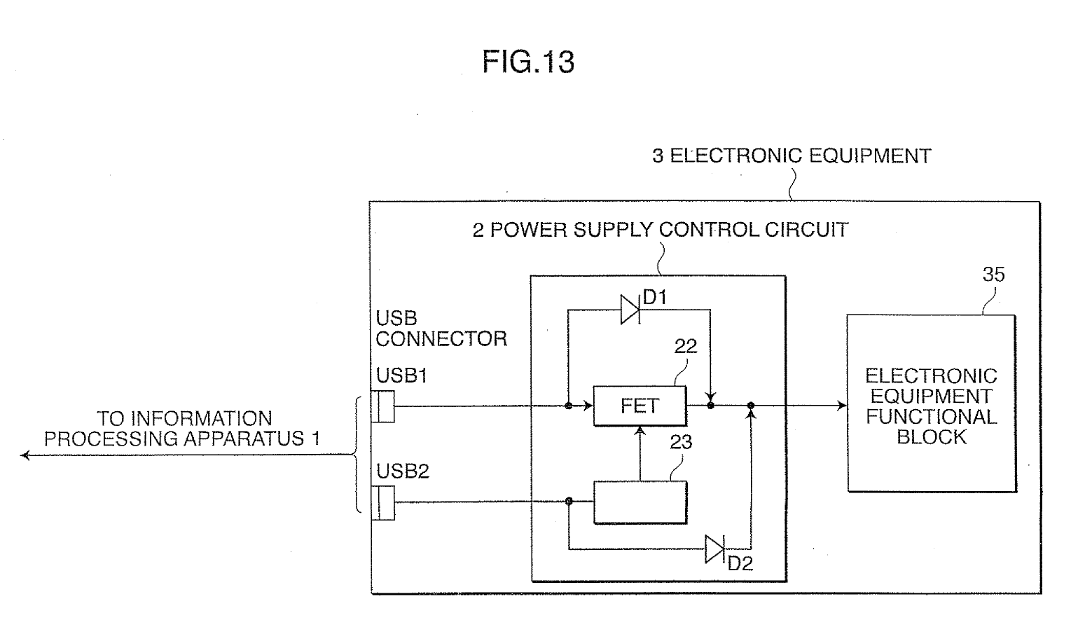

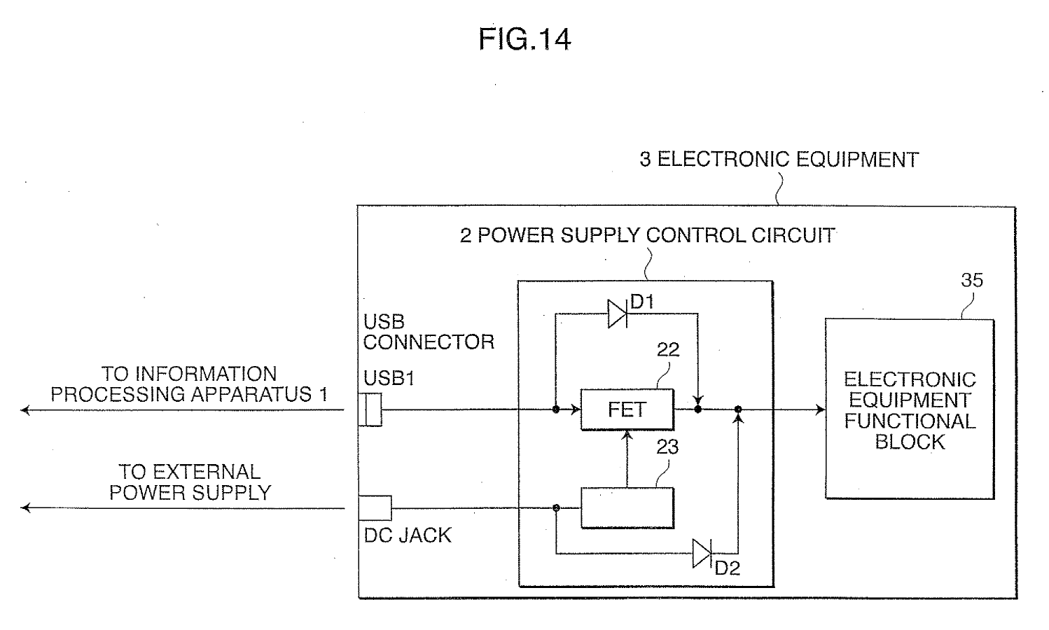

FIGS. 13 and 14 are diagrams for describing preferred embodiments which incorporate a power supply control circuit 2 in the inside of electronic equipment 3 that receives a power supply.

In this case, the power supply control circuit 2 is provided between a section (electronic equipment functional block 35) which realizes an original function of the electronic equipment 3 and external terminals (for example, USB connector and DCjack) which connect cables for connecting an external information processing apparatus 1.

In a case of FIG. 13, usually used USB cables are connected at two USB connectors (USB1 and USB2) and connected to the information processing apparatus 1. As for data, the USB1 side is also used in this case.

FIG. 14 shows an embodiment in which a DCjack is provided in place of one of the USB connectors (USB2). An external power supply such as an AC adapter and a USB power supply auxiliary cable can also be connected to the DCjack.

Preferred embodiments shown in FIGS. 11 to 14 are one embodiment, and it is not limited to this; but, it can be realized by other preferred embodiment. For example, in a case where an integrated connector module having plural connector terminals, the power supply control circuit 2 according to the present invention may be provided in the inside of the connector module.

According to the present invention, the current control unit including the first diode D1 and the field effect transistor FET which are connected in parallel is connected to the first input line, the connection detection unit, which detects a state of supplying a power supply to the second input line and controls an operation of the field effect transistor FET, and the second diode D2 are connected to the second input line; and therefore, a power supply loss can be reduced in a case of supplying a power supply via one input line, and it is possible to prevent a current from inversely flowing to the input line side in a case of supplying a power supply via plural input lines,

What is claimed is:

1. A power supply control circuit comprising:
an input unit which receives a supply of a power supply from one or a plurality of power supply source apparatuses, and has plural input lines including a first input line and a second input line at least;
an output unit which outputs the supplied power supply to a power supply destination apparatus;
a current control unit which is arranged between the first input line and the output unit, and includes a first diode D1 and a field effect transistor FET which are connected in parallel;
a connection detection unit which is arranged between the second input line and the current control unit, detects a state of supplying the power supply to the second input line, and controls the field effect transistor FET; and
a second diode D2 arranged between the second input line and the output unit.

2. The power supply control circuit according to claim 1, wherein
directions in forward directions of three diodes such as the first diode D1, the second diode D2, and a parasitic diode existing between a drain and a source of the field effect transistor FET are the same as a power supply current flowing from the input unit to the output unit, and
a forward voltage of the diode D1 is smaller than a forward voltage of the parasitic diode in the field effect transistor FET.

3. A power supply control circuit comprising:
an input unit which receives a supply of a power supply from a power supply source apparatus, and has plural input lines;
an output unit which outputs the supplied power supply to a power supply destination apparatus;
a current control unit which is arranged between a first input line IN1 and the output unit, and includes a field effect transistor FET and a first diode D1 which are connected in parallel with each other to the first input line IN1;
a connection detection unit which detects that a power supply is supplied to an input line different from the first input line IN1, and controls the field effect transistor FET; and
a second diode D2 arranged between the input line different from the first input line IN1 and the output unit, wherein
directions in forward directions of the first and the second diodes are the same as a flowing direction of a power supply current, and
the connection detection unit controls the field effect transistor so that the power supply current supplied from the first input line IN1 flows to the output unit via the field effect transistor FET in a case where the connection detection unit detects that the power supply is not supplied to the input line different from the first input line IN1, and the power supply current supplied from the first input line IN1 flows to the output unit via the first diode D1 in a case where the connection detection unit detects that the power supply is supplied to the input line different from the first input line IN1.

4. The power supply control circuit according to any one of claims 1, 2, and 3, wherein
the input unit includes two input lines, and
each of the input lines includes a signal line which transmits a signal and a power supply line which supplies a power supply.

5. The power supply control circuit according to claim 4, wherein
the input line is capable of connecting a hot-pluggable interface cable.

6. The power supply control circuit according to any one of claims 1, 2, and 3, wherein
the input unit includes two input lines,
the first input line includes a signal line which transmits a signal and a power supply line which supplies a power supply, and
the second input line includes only a power supply line which supplies a power supply.

7. The power supply control circuit according to claim 6, wherein
the second input line is capable of connecting an AC adapter.

8. The power supply control circuit according to claim 3, wherein
the field effect transistor FET is arranged so that a direction in a forward direction of a parasitic diode existing between a drain and a source thereof is the same as the direction in the forward direction of the first diode.

9. The power supply control circuit according to claim 8, wherein
the drain of the field effect transistor FET and an anode of the first diode D1 are connected to the first input line, and
the source of the field effect transistor FET and a cathode of the first diode D1 are connected to the output unit.

10. The power supply control circuit according to any one of claims 1, 2, and 3, wherein
an anode of the second diode D2 is connected to the second input line, and
a cathode of the second diode D2 is connected to the output unit.

11. The power supply control circuit according to any one of claims 1, 2, and 3, wherein
the input unit includes two input lines, and
the second diode D2 is not provided in a case where a power supply voltage (V2) supplied from the second input line is equivalent to or higher than a power supply voltage (V1) supplied from the first input line.

12. An interface connection cable comprising:
a power supply control circuit as set forth in any one of claims 1, 2, and 3;
an input side cable which connects the input unit to the power supply source apparatus; and
an output side cable which connects the output unit to the power supply destination apparatus.

13. A power supply destination apparatus which receives a supply of a power supply from a power supply control circuit as set forth in any one of claims 1, 2, and 3, wherein
the power supply control circuit is provided in the apparatus.
